(19) United States
(12) Patent Application Publication
(10) Pub. No.: US 2025/0245808 A1
(43) Pub. Date: Jul. 31, 2025

(54) System, Apparatus and Method for Controlling Welding of Secondary Battery Based on Artificial Intelligence

(71) Applicant: SK On Co., Ltd., Seoul (KR)

(72) Inventors: Oh San AN, Daejeon (KR); Hyo Sung HONG, Daejeon (KR); Jae Hun KIM, Daejeon (KR); Hyeong Won KIM, Daejeon (KR); Hyeon Jeong YOU, Daejeon (KR)

(21) Appl. No.: 19/034,788

(22) Filed: Jan. 23, 2025

(30) Foreign Application Priority Data
Jan. 29, 2024 (KR) 10-2024-0013418

(51) Int. Cl. G06T 7/00; B23K 20/10; B23K 26/03; G05B 13/02; G06T 7/70; G06V 10/25; G06V 10/70

(52) U.S. Cl. CPC G06T 7/0004; G05B 13/0265; G06T 7/70; G06V 10/25; G06V 10/70; B23K 20/10; B23K 26/032; G06T 2207/20081; G06V 2201/06

(57) ABSTRACT

The present disclosure provides a system, apparatus and method for controlling welding based on artificial intelligence. The artificial intelligence-based welding control system according to an embodiment of the present disclosure may include a machine vision system configured to photograph at least a portion of a welding object through a camera, and transmit the photographed image (hereinafter, “photography image”) to a relay system; the relay system configured to receive the photography image from the machine vision system, recognize a welding position of the welding object from the received photography image based on a pre-trained first artificial intelligence model, determine whether the recognized welding position is included in a designated position range, and when the recognized welding position is included in the designated position range, transmit the recognized welding position to a welding system; and the welding system configured to receive the welding position from the relay system, and perform welding at the received welding position.

### CROSS-REFERENCE TO RELATED APPLICATIONS

This application claims priority to Korean Patent Application No. 10-2024-0013418 filed on Jan. 29, 2024, the disclosure of which is incorporated herein by reference in its entirety.

### BACKGROUND OF THE INVENTION

### 1. Field of the Invention

The present disclosure relates to a system, apparatus and method for controlling welding based on artificial intelligence.

### 2. Description of the Related Art

A secondary battery is a battery that can be repeatedly charged and discharged. With rapid progress of information and communication, and display industries, the secondary battery has been widely applied to various portable electronic telecommunication devices such as a camcorder, a mobile phone, a tablet personal computer (PC), a laptop PC, etc. as a power source thereof. Recently, a battery pack including the secondary battery has also been developed as a power source of an eco-friendly automobile such as an electric vehicle.

When manufacturing the battery module or the battery pack, some configurations may be welded (e.g., laser-welded, ultrasonically-welded, etc.). For example, when connecting battery cells in series, a cathode of a battery cell and an anode of another battery cell may be welded. Or otherwise, when connecting the battery cells in parallel, the cathodes of the battery cells may be welded and the anodes may be welded.

Meanwhile, the welding may be automatically performed through a system for controlling welding (hereinafter, “a welding control system”). For example, the welding control system may photograph an object to be welded (hereinafter, “a welding object”) (e.g., an electrode portion of the battery cell) through a camera, identify (recognize) a welding position (e.g., an edge of the electrode) from the photography image through a machine vision technology, and weld the identified welding position. However, there is a problem in that the machine vision technology may misrecognize scratches, etc. as the welding position. In addition, the machine vision technology of the welding control system may have a problem in that the quality of the image may vary depending on the photographing environment (e.g., brightness, contamination of a camera lens, state of the welding object (e.g., tolerance), installation state of an assembly tool (jig)), thereby resulting in misrecognition of the welding position.

### SUMMARY OF THE INVENTION

An object of the present disclosure is to provide a system, apparatus and method for controlling welding based on artificial intelligence, which may improve recognition performance of a welding position.

In addition, another object of the present disclosure is to provide a system, apparatus and method for controlling welding based on artificial intelligence, which may improve a recognition rate of an artificial intelligence model.

Further, another object of the present disclosure is to provide a system, apparatus and method for controlling welding based on artificial intelligence, which may improve efficiency of a welding position.

To achieve the above object, according to an aspect of the present invention, there is provided a system for controlling welding based on artificial intelligence, the system including: a machine vision system configured to photograph at least a portion of a welding object through a camera, and transmit the photographed image (hereinafter, “photography image”) to a relay system; the relay system configured to receive the photography image from the machine vision system, recognize a welding position of the welding object from the received photography image based on a pre-trained first artificial intelligence model, determine whether the recognized welding position is included in a designated position range, and when the recognized welding position is included in the designated position range, transmit the recognized welding position to a welding system; and the welding system configured to receive the welding position from the relay system, and perform welding at the received welding position.

According to an embodiment, if the recognized welding position is not included in the designated position range or the welding position is not recognized from the photography image, the relay system may generate an alarm.

According to an embodiment, if the recognized welding position is not included in the designated position range or the welding position is not recognized from the photography image, the relay system may request the machine vision system to identify a welding position. If an identification of the welding position is requested, the machine vision system may identify the welding position from the photography image, determine whether the identified welding position is included in the designated position range, and if the identified welding position is included in the designated position range, transmit the identified welding position to the welding system.

According to an embodiment, if the identified welding position is not included in the designated position range or the welding position is not identified from the photography image, the machine vision system may generate an alarm.

According to an embodiment, the machine vision system may attempt to identify a welding position from the photography image after photographing at least a portion of the welding object, and if the welding position is not identified from the photography image or the identified welding position is not included in the designated position range, transmit the photography image to the relay system.

According to an embodiment, if the identified welding position is included in the designated position range, the machine vision system may transmit the identified welding position to the welding system.

According to an embodiment, the relay system may extract a region of interest from the photography image based on a pre-trained second artificial intelligence model, and transmit information on the extracted region of interest to the machine vision system. The machine vision system may identify a welding position within the region of interest of the photography image, and transmit the identified welding position to the welding system.

According to an embodiment, the system may further include an inspection system configured to inspect whether a welding defect is present after performing the welding, and if the welding defect is present, transmit welding defect information to the relay system. The relay system may update the first artificial intelligence model based on the welding defect information.

According to an embodiment, the relay system may include: an artificial intelligence server which includes the first artificial intelligence model; and a relay server configured to relay communication between the machine vision system, the welding system, and the artificial intelligence server.

According to an embodiment, the welding object may include a secondary battery. The welding position may include an edge of an electrode of the secondary battery.

In addition, according to another aspect of the present invention, there is provided a method for controlling welding based on artificial intelligence, the method including: photographing at least a part of the welding object through a camera, and transmitting the photographed image (hereinafter, “photography image”) to a relay system by a machine vision system; receiving the photography image from the machine vision system, recognizing a welding position of the welding object from the received photography image based on a pre-trained first artificial intelligence model, determining whether the recognized welding position is included in a designated position range, and when the recognized welding position is included in the designated position range, transmitting the recognized welding position to a welding system by the relay system; receiving the welding position from the relay system, and performing welding at the received welding position by the welding system.

According to an embodiment, the method may further include, if the recognized welding position is not included in the designated position range or the welding position is not recognized from the photography image, generating an alarm by the relay system.

According to an embodiment, the method may further include: if the recognized welding position is not included in the designated position range or the welding position is not recognized from the photography image, requesting the machine vision system to identify a welding position by the relay system; and if an identification of the welding position is requested, identifying the welding position from the photography image, determining whether the identified welding position is included in the designated position range, and if the identified welding position is included in the designated position range, transmitting the identified welding position to the welding system by the machine vision system.

According to an embodiment, the method may further include, if the identified welding position is not included in the designated position range or the welding position is not identified from the photography image, generating an alarm by the machine vision system.

According to an embodiment, the method may further include attempting to identify a welding position from the photography image after photographing at least a portion of the welding object by the machine vision system. If the welding position is not identified from the photography image or the identified welding position is not included in the designated position range, the step of transmitting the photography image to the relay system may be performed.

According to an embodiment, the method may further include, if the identified welding position is included in the designated position range, transmitting the identified welding position to the welding system by the machine vision system.

According to an embodiment, the method may further include: extracting a region of interest from the photography image based on a pre-trained second artificial intelligence model, and transmitting information on the extracted region of interest to the machine vision system by the relay system; and identifying a welding position within the region of interest of the photography image, and transmitting the identified welding position to the welding system by the machine vision system.

According to an embodiment, the method may further include: inspecting whether a welding defect is present through an inspection system after performing the welding; if the welding defect is present, transmitting welding defect information to the relay system; and updating the first artificial intelligence model based on the welding defect information by the relay system.

Further, according to another aspect of the present invention, there is provided an apparatus for controlling welding based on artificial intelligence, the apparatus including: a camera; a memory which includes a pre-trained artificial intelligence model; a welding module; and a processor configured to control the camera to photograph at least a portion of a welding object, recognize a welding position from the image photographed through the camera (hereinafter, “photography image”) based on the artificial intelligence model, determine whether the recognized welding position is included in a designated position range, and when the recognized welding position is included in the designated position range, control the welding module to weld the recognized welding position.

According to an embodiment, the apparatus may further include an inspection module. The processor may determine whether a welding defect is present through the inspection module after performing the welding, and if the welding defect is present, update the artificial intelligence model based on welding defect information.

According to an embodiment of the present disclosure, the recognition performance of the welding position may be improved. For example, the present disclosure may recognize a welding position on the photography image and determine whether the recognized welding position is included within the designated position range. The present disclosure may accurately detect the welding position.

In addition, the present disclosure may extract a region of interest (e.g., a welding portion) from the photography image, and recognize the welding position in the extracted region of interest. The present disclosure may accurately detect the welding position (e.g., improve the accuracy) and minimize (or prevent) misrecognition.

In addition, the present disclosure may prevent misrecognition of the welding position depending on the photographing environment. For example, the present disclosure may train an artificial intelligence model based on images captured in various environments, thereby minimizing the influence depending on the photographing environment.

Further, the present disclosure may improve (or enhance) the recognition rate of the artificial intelligence model. For example, the present disclosure may perform a welding defect inspection after welding is completed, additionally train the artificial intelligence model based on the photography images in which the welding defect has occurred, and continuously update the artificial intelligence model to improve (or enhance) the recognition rate of the artificial intelligence model.

Furthermore, the present disclosure may efficiently recognize the welding position by combining machine vision recognition and artificial intelligence recognition. For example, the present disclosure may recognize the welding position in a more suitable manner for a situation by individually or in combination using the machine vision recognition and artificial intelligence recognition

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view schematically illustrating a system for controlling welding based on artificial intelligence (hereinafter, “an artificial intelligence-based welding control system”) according to an embodiment of the present disclosure;

FIG. 2 is a view illustrating a structure of the artificial intelligence model according to an embodiment of the present disclosure;

FIG. 3 is a flowchart for describing a method for controlling welding (hereinafter, “a welding control method”) of the artificial intelligence-based welding control system according to an embodiment of the present disclosure;

FIG. 4 is a flowchart for describing a welding control method of an artificial intelligence-based welding control system according to another embodiment of the present disclosure;

FIG. 5 is a flowchart for describing a welding control method of an artificial intelligence-based welding control system according to another embodiment of the present disclosure;

FIG. 6A is a flowchart for describing a welding control method of an artificial intelligence-based welding control system according to another embodiment of the present disclosure;

FIG. 6B is an exemplary diagram for describing a welding control method of an artificial intelligence-based welding control system according to another embodiment of the present disclosure;

FIG. 7 is a view schematically illustrating an artificial intelligence-based welding control system according to another embodiment of the present disclosure; and

FIG. 8 is a flowchart for describing a welding control method of the artificial intelligence-based welding control system according to another embodiment of the present disclosure;

FIG. 9 is a block diagram illustrating a configuration of an apparatus for controlling welding based on artificial intelligence (hereinafter, “an artificial intelligence-based welding control apparatus”) according to an embodiment of the present disclosure.

### DETAILED DESCRIPTION OF THE INVENTION

Hereinafter, the present disclosure will be described in detail through embodiments with reference to the accompanying drawings. However, the embodiments are merely illustrative and the present disclosure is not limited to the specific embodiments described by way of example.

Although a first, a second, and the like are used to describe various elements, components and/or sections, these elements, components and/or sections are of course not limited by these terms. These terms are merely used to distinguish one element, component and/or section from another element, component and/or section. Therefore, it goes without saying that the first element, first component or first section mentioned below may also be the second element, second component or second section within the technical spirit of the present disclosure.

Terms used herein are for the purpose of describing particular embodiments only and are not intended to limit the present disclosure thereto. As used herein, singular forms are intended to include the plural forms as well, unless the context clearly indicates otherwise. It will be further understood that the terms “comprises” and/or “made of,” as used herein, do not preclude the presence or addition of one or more components, steps, operations and/or elements other than those mentioned component, step, operation and/or element.

Unless otherwise defined, all terms (including technical and scientific terms) used herein have the same meaning as commonly understood by one of ordinary skill in the art to which the present disclosure pertains. Terms, such as those defined in commonly used dictionaries, are not to be construed in an idealized or overly formal sense unless expressly so defined herein.

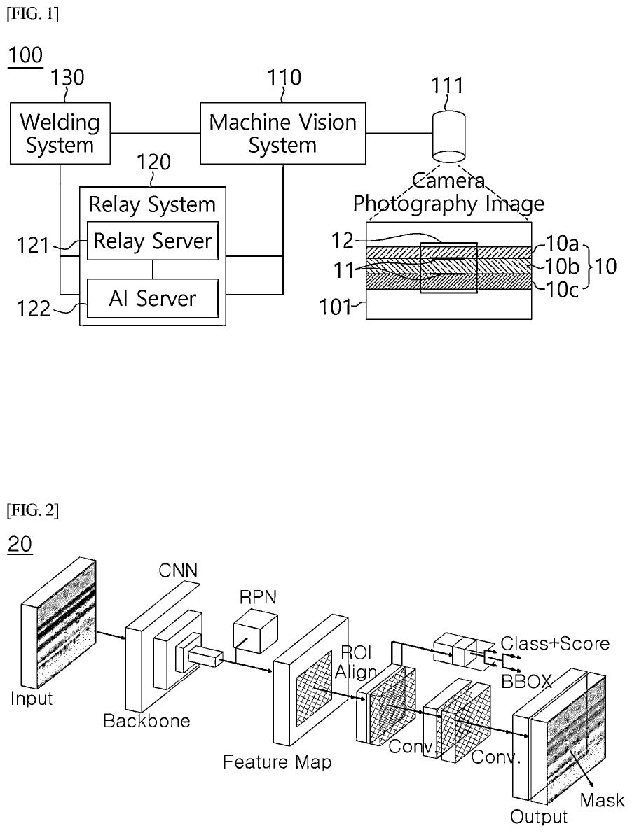

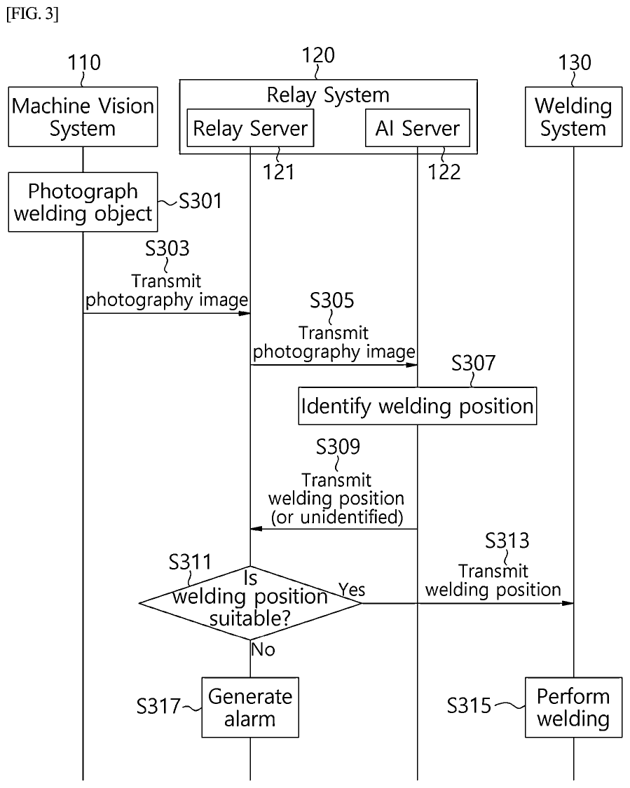

FIG. 1 is a schematic diagram illustrating an artificial intelligence-based welding control system according to an embodiment of the present disclosure, and FIG. 2 is a view illustrating a structure of the artificial intelligence model according to an embodiment of the present disclosure.

Referring to FIGS. 1 and 2, an artificial intelligence-based welding control system 100 according to an embodiment of the present disclosure may include a machine vision system 110, a relay system 120 and a welding system 130.

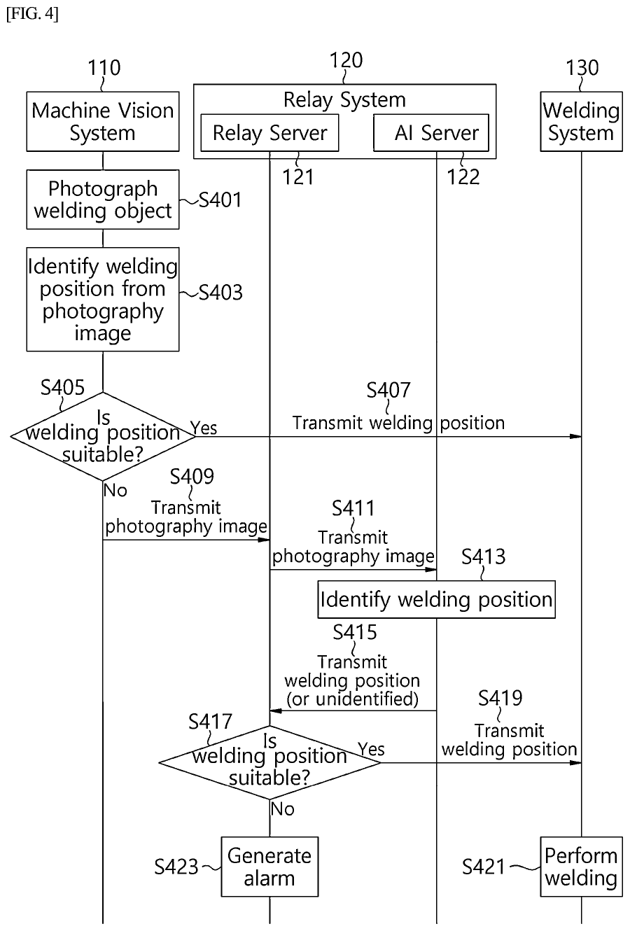

The machine vision system 110 may photograph at least a portion (hereinafter, a welding portion) 10 of a welding object (e.g., a secondary battery) through a camera 111, and transmit the photographed image (hereinafter, a photography image) 101 to the relay system 120. The welding portion 10 may include, for example, electrodes 10a, 10b and 10c of the secondary battery, a case of the secondary battery (e.g., a case of a battery module, a case of a square-shaped battery, a case of a cylindrical-shaped battery), and a foil of the secondary battery. According to some embodiments, the machine vision system 110 may identify (or recognize) a welding position (e.g., an edge of the electrode of the secondary battery) from the photography image 101 using the machine vision technology, and transmit (or transfer) the identified welding position to the welding system 130. Operations of the machine vision system 110 according to various embodiments of the present disclosure will be described below with reference to FIGS. 3 to 6B.

The relay system 120 is communicatively connected to the machine vision system 110 and the welding system 130, and may control (or manage) an overall operation of the welding control system 100. According to an embodiment, the relay system 120 may include a relay server 121 and an artificial intelligence (AI) server 122.

The relay server 121 may control (e.g., relay) communication (e.g., data transmission and reception) between the machine vision system 110, the welding system 130 and the artificial intelligence server 122. The relay server 121 may control an overall operation of the relay system 120 (e.g., introduction and discharge of the welding object, artificial intelligence-based welding position recognition, machine vision-based welding position recognition, alarm generation, and initialization, etc.). In addition, the relay server 121 may receive an input (e.g., an operation command) of a user for an operation of the relay system 120, and output the state of the relay system 120.

The artificial intelligence server 122 may include an artificial intelligence model (hereinafter, referred to as a first artificial intelligence model) 20. As shown in FIG. 2, when the photography image 101 is input, the first artificial intelligence model 20 may generate a feature map through a convolutional neural network (CNN), estimate candidate regions of interest (ROIs) through a region proposal network (RPN), classify classes of the estimated candidate regions of interest (ROIs), recognize a welding position based on the classification result, and output the recognized welding position while being masked. Meanwhile, the structure of the first artificial intelligence model 20 shown in FIG. 2 is merely an example and does not limit the present disclosure.

The first artificial intelligence model 20 may be trained based on images captured in various environments. Through this, the present disclosure may minimize (or prevent) the influence (e.g., misrecognition) due to the photographing environment (e.g., brightness, contamination of the camera lens, state of the welding object (e.g., tolerance), installation state of the assembly tool (jig), etc.).

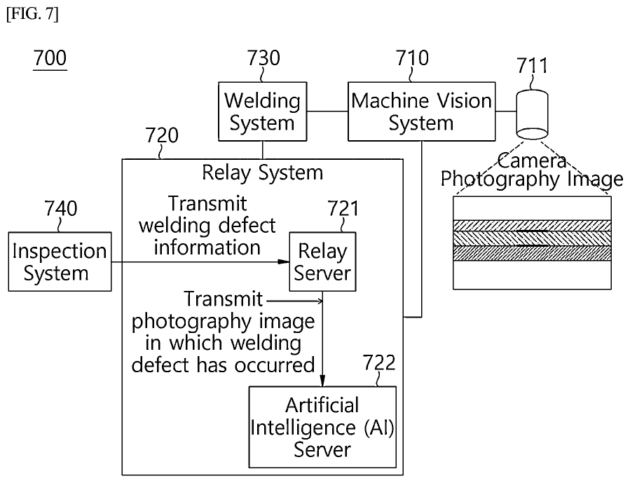

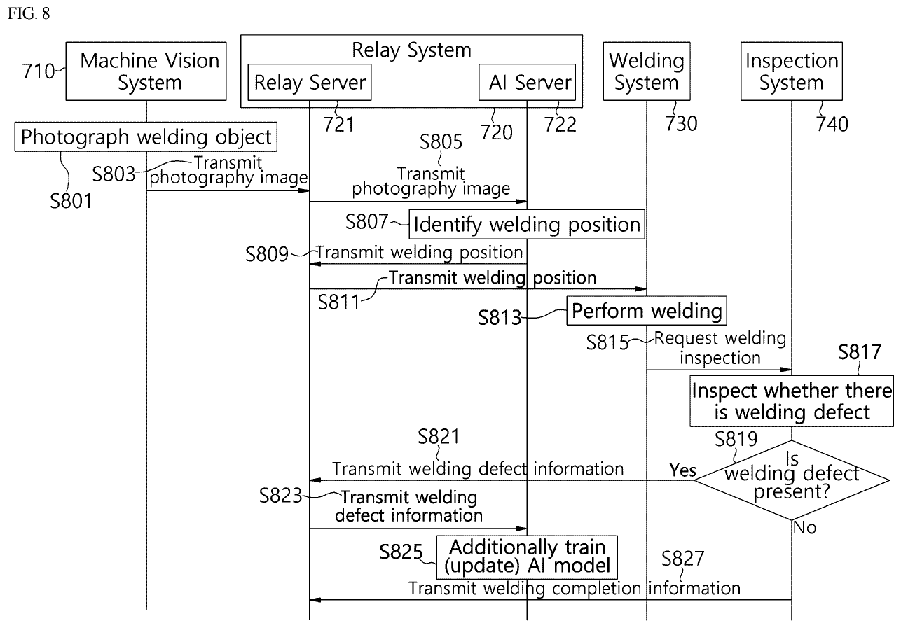

The first artificial intelligence model 20 may be additionally trained based on the photography image of the welding object in which a welding defect (e.g., caused by welding performed at a wrong position) has occurred, which will be described in detail below with reference to FIGS. 7 and 8.

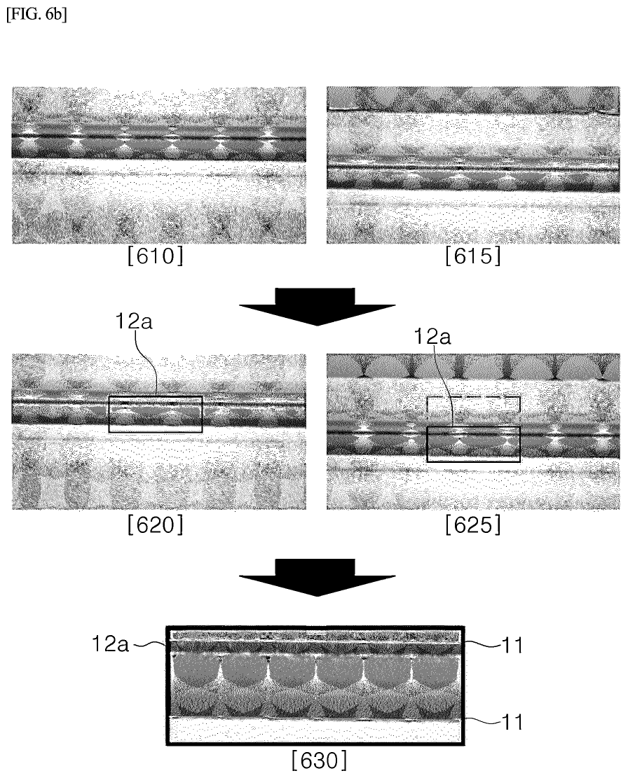

Meanwhile, the artificial intelligence server 122 may include a second artificial intelligence model (not shown) configured to extract a region of interest for recognizing a welding position from the photography image, which will be described in detail below with reference to FIGS. 6A and 6B.

According to an embodiment, the relay system 120 may identify a welding position 11 from the photography image 101 based on the pre-trained first artificial intelligence model 20, and transmit the identified welding position 11 to the welding system 130. For example, the relay system 120 may receive the photography image 101 from the machine vision system 110, analyze the received photography image 101 based on the first artificial intelligence model 20 to recognize the welding position 11, determine whether the recognized welding position 11 is included in a designated position range 12, and if the recognized welding position 11 is included in the designated position range 12, transmit the recognized welding position 11 to the welding system 130, which will be described in detail below with reference to FIG. 3.

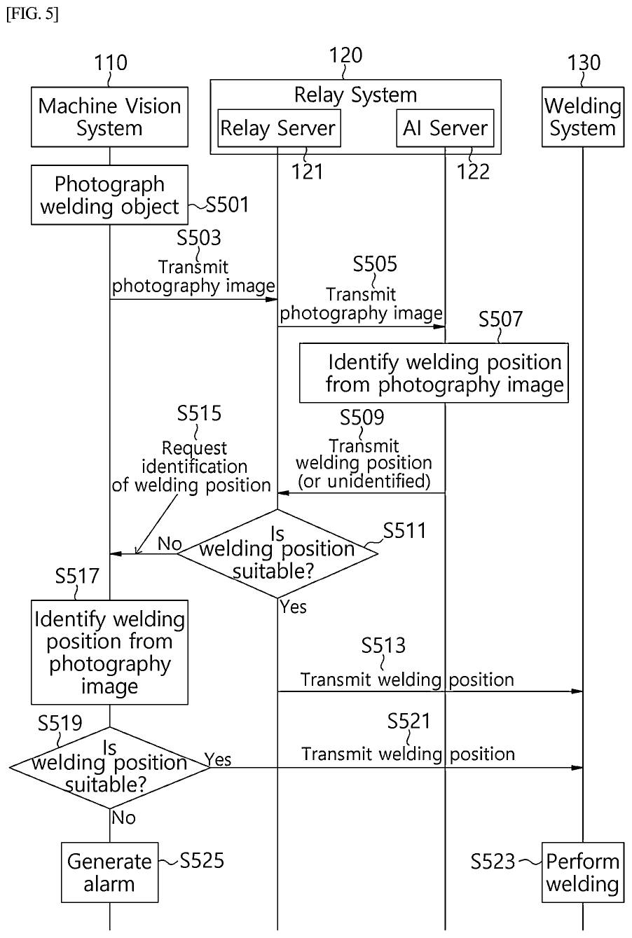

According to an embodiment, if the welding position is not identified by the machine vision system 110 or the identified welding position is not included in the designated position range, the relay system 120 may receive a photography image from the machine vision system 110 and recognize the welding position from the photography image, which will be described in detail below with reference to FIG. 4.

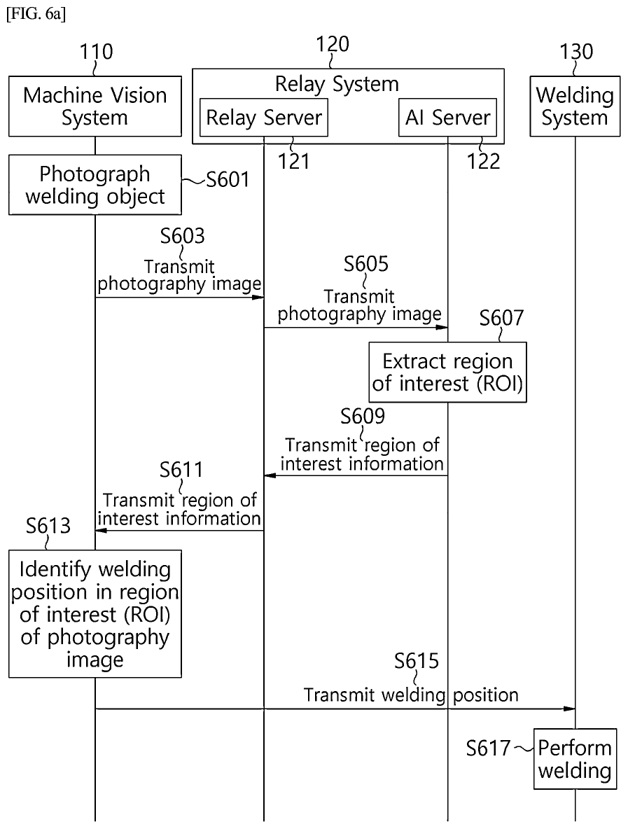

According to an embodiment, if the recognized welding position is not included in the designated position range or the welding position is not recognized from the photography image, the relay system 120 may request the machine vision system 110 to identify a welding position, which will be described in detail below with reference to FIG. 5.

According to an embodiment, the relay system 120 may extract a region of interest from the photography image based on the second artificial intelligence model which is different from the first artificial intelligence model 20, and transmit information on the extracted region of interest to the machine vision system 110. In this case, the machine vision system 110 may identify the welding position within the region of interest, which will be described in detail below with reference to FIGS. 6A and 6B.

The welding system 130 may receive the welding position 11 from the relay system 120 or the machine vision system 110, and perform welding (e.g., laser welding, ultrasonic welding) at the received welding position 11. For example, the welding system 130 may weld at least a portion of a boundary between a first electrode 10a and a second electrode 10b and at least a portion of a boundary between the second electrode 10b and a third electrode 10c.

FIG. 3 is a flowchart for describing a welding control method of the artificial intelligence-based welding control system according to an embodiment of the present disclosure.

Referring to FIG. 3, the welding control method of the artificial intelligence-based welding control system according to an embodiment of the present disclosure may include a step (S301) of photographing a welding object. For example, the machine vision system 110 may photograph at least a portion (e.g., a welding portion) of a welding object (e.g., a secondary battery) through the camera 111. Here, the welding portion may include an electrode of the secondary battery.

The welding control method may include a step (S303) of transmitting the photography image to the relay server 121. For example, the machine vision system 110 may transmit the photography image to the relay server 121 of the relay system 120 through wired or wireless communication. The welding control method may include a step (S305) of transmitting the photography image to the artificial intelligence server 122. For example, the relay server 121 may transmit the photography image to the artificial intelligence server 122 through wired or wireless communication.

The welding control method may include a step (S307) of identifying a welding position. For example, the artificial intelligence server 122 may identify (or recognize) the welding position from the photography image based on the pre-trained first artificial intelligence model.

The welding control method may include a step (S309) of transmitting the welding position. For example, the artificial intelligence server 122 may transmit the recognized welding position (e.g., coordinates) to the relay server 121 through wired or wireless communication. Meanwhile, if the welding position is not identified, the artificial intelligence server 122 may transmit information on the unidentified position to the relay server 121.

The welding control method may include a step (S311) of determining whether the welding position is suitable. For example, when the welding position is included in the designated position range, the relay server 121 of the relay system 120 may determine that it is suitable. On the other hand, if the welding position is not identified or the identified welding position is not included in the designated position range, the relay server 121 may determine that it is not suitable. The position range is a region estimated that a part (e.g., an electrode of the secondary battery) on which welding will be performed is located on the photography image, and may be pre-designated by the user. Through this, the present disclosure may suppress (or prevent) the problem that welding defects occur due to misrecognition of the welding position.

As a result of the determination in the step S311, if it is determined that the welding position is suitable, the welding control method may perform a step (S313) of transmitting the welding position to the welding system 130. For example, the relay server 121 of the relay system 120 may transmit the welding position to the welding system 130 through wired or wireless communication. The welding control method may include a step (S315) of performing welding. For example, the welding system 130 may perform welding at the welding position.

Meanwhile, as a result of the determination in the step S311, if it is determined that the welding position is not suitable, the welding control method may proceed to a step (S317) of generating an alarm. For example, the relay server 121 of the relay system 120 may generate an alarm (e.g., output a sound effect, emit a light, generate a vibration, etc.) in various designated ways (e.g., auditory, visual, tactile, etc.). Meanwhile, although not shown in the drawings, the relay server 121 may also generate an alarm through the machine vision system 110 and/or the welding system 130.

FIG. 4 is a flowchart for describing a welding control method of an artificial intelligence-based welding control system according to another embodiment of the present disclosure.

Referring to FIG. 4, the welding control method of the artificial intelligence-based welding control system according to another embodiment of the present disclosure may include a step (S401) of photographing a welding object. For example, the machine vision system 110 may photograph at least a portion (e.g., a welding portion) of a welding object (e.g., a secondary battery) through the camera 111. Here, the welding portion may include an electrode of the secondary battery.

The welding control method may include a step (S403) of identifying a welding position from the photography image. For example, the machine vision system 110 may identify the welding position from the photography image based on the machine vision technology.

The welding control method may include a step (S405) of determining whether the welding position is suitable. For example, when the welding position is included in a designated position range, the machine vision system 110 may determine that it is suitable. On the other hand, if the welding position is not identified or the identified welding position is not included in the designated position range, the machine vision system 110 may determine that it is not suitable.

As a result of the determination in the step S405 above, if it is determined that the welding position is suitable, the welding control method may perform a step (S407) of transmitting the welding position to the welding system. For example, the machine vision system 110 may transmit the welding position to the welding system 130 through wired or wireless communication.

On the other hand, as a result of the determination in the step S405, if it is determined that the welding position is not suitable, the welding control method may proceed to step S409. Here, steps S409, S411, S413, S415, S417, S419, S421 and S423 of FIG. 4 are the same as the steps S303, S305, S307, S309, S311, S313, S315 and S317 of FIG. 3, respectively, and therefore will not be described in detail.

FIG. 5 is a flowchart for describing a welding control method of an artificial intelligence-based welding control system according to another embodiment of the present disclosure.

Referring to FIG. 5, steps S501, S503, S505, S507, S509, “Yes” of S511, S513 and S523 of the welding control method of the artificial intelligence-based welding control system according to another embodiment of the present disclosure are the same as the steps S301, S303, S305, S307, S309, “Yes” of S311, S313 and S315 of FIG. 3, and therefore will not be described in detail.

Meanwhile, as a result of the determination in the step S511, if it is determined that the welding position is not suitable, the welding control method may perform a step (S515) of requesting the machine vision system 110 to identify a welding position. For example, the relay server 121 of the relay system 120 may request the machine vision system 110 to identify a welding position through wired or wireless communication.

The welding control method may include a step (S517) of identifying the welding position from the photography image. For example, the machine vision system 110 may identify the welding position from the photography image based on the machine vision technology.

The welding control method may include a step (S519) of determining whether the welding position is suitable. For example, when the welding position is included in the designated position range, the machine vision system 110 may determine that it is suitable. On the other hand, if the welding position is not identified or the identified welding position is not included in the designated position range, the machine vision system 110 may determine that it is not suitable.

As a result of the determination in the step S519, if it is determined that the welding position is suitable, the welding control method may perform a step (S521) of transmitting the welding position to the welding system and a step (S523) of performing welding. For example, the machine vision system 110 may transmit the welding position to the welding system 130 through wired or wireless communication. In this case, the welding system 130 may perform welding at the received welding position.

On the other hand, as a result of the determination in the step S519, if it is determined that the welding position is not suitable, the welding control method may perform a step (S525) of generating an alarm. For example, the machine vision system 110 may generate an alarm (e.g., output a sound effect, emit a light, generate a vibration, etc.) in various designated ways (e.g., auditory, visual, tactile, etc.). Meanwhile, although not shown in the drawings, the machine vision system 110 may also generate an alarm through the relay system 120 and/or the welding system 130.

The above-described embodiments of FIGS. 4 and 5 may use a method more suitable for the situation by individually or in combination with the conventional machine vision-based welding position recognition and artificial intelligence-based welding position recognition, efficiently recognize the welding position, and further improve the accuracy of recognition.

FIG. 6A is a flowchart for describing a welding control method of an artificial intelligence-based welding control system according to another embodiment of the present disclosure.

Referring to FIG. 6A, steps S601, S603 and S605 of the welding control method of the artificial intelligence-based welding control system according to another embodiment of the present disclosure are the same as the steps S301, S303 and S305 of FIG. 3, and therefore will not be described in detail.

The welding control method may include a step (S607) of extracting a region of interest. For example, the artificial intelligence server 122 may extract a region of interest from the photography image using the pre-trained second artificial intelligence model. The region of interest may include a partial configuration (or partial region) (e.g., an electrode of the secondary battery) on which welding will be performed among the configurations (or entire region) of the welding object. For example, the second artificial intelligence model may extract a partial region (e.g., a region including the electrode of the secondary battery) of the photography image as the region of interest.

The welding control method may include a step of transmitting information on the region of interest to the machine vision system 110. For example, the artificial intelligence server 122 may the transmit information on the region of interest to the relay server 121 (S609), and the relay server 121 may transmit the information on the region of interest to the machine vision system 110 (S611).

The welding control method may include a step of identifying a welding position in the region of interest of the photography image (S613). For example, the machine vision system 110 may identify a welding position (e.g., an edge of the electrode of the secondary battery) from the region of interest of the photography image using the machine vision technology.

The welding control method may include a step of transmitting the welding position to the welding system (S615) and a step of performing welding (S617). For example, the machine vision system 110 may transmit the welding position to the welding system 130 through wired or wireless communication. When the welding position is received from the machine vision system 110, the welding system 130 may perform welding at the received welding position.

FIG. 6B is an exemplary diagram for describing a welding control method of an artificial intelligence-based welding control system according to another embodiment of the present disclosure.

Referring to FIG. 6B, the arrangement state (or photographing position) of the welding object may not be constant due to various reasons (e.g., assembly tolerance, installation state of the assembly mechanism, etc.). For example, the welding position of the welding object may be located at an upper portion of the photography image as shown in the drawing by identification symbol 610 in FIG. 6B, or may be located at a middle portion of the photography image as shown in the drawing by identification symbol 615. Hereinafter, for the convenience of description, the arrangement state as shown in the drawing by identification symbol 610 of FIG. 6B will be described as a normal state, and the arrangement state as shown in the drawing by identification symbol 615 will be described as an abnormal state.

When the arrangement state of the welding object is the normal state, the welding position of the welding object may be included in a designated region of interest 12a as shown in the drawing by identification symbol 620 of FIG. 6B. However, if the arrangement state of the welding object is the abnormal state, the welding position of the welding object may not be included in the designated region of interest indicated by the dotted line as shown in the drawing by identification symbol 625 of FIG. 6B. However, the artificial intelligence server 122 according to the present disclosure may extract the region of interest 12a through the second artificial intelligence model, rather than the region of interest of the designated position (e.g., the embodiments of FIGS. 3 to 5). Accordingly, the present disclosure may resolve the inconvenience of having to place the welding object in the correct position. In addition, the present disclosure may prevent the problem that the welding position is misrecognized or not recognized because the welding object is not placed in the correct position.

The machine vision system 110 according to the present disclosure may identify the welding position 11 in the region of interest 12a. In this way, even if the welding object is incorrectly placed, the present disclosure may identify the welding position more accurately by extracting the region of interest where the welding position will be identified through the second artificial intelligence model, and identifying the welding position within the extracted region of interest.

Meanwhile, although FIGS. 6A and 6B illustrate and describe that the machine vision system 110 identifies the welding position in the region of interest, the artificial intelligence server 122 may also identify the welding position in the region of interest. For example, the artificial intelligence server 122 may extract a region of interest from the photography image through the second artificial intelligence model, and identify the welding position in the extracted region of interest through the first artificial intelligence model 20.

FIG. 7 is a view schematically illustrating an artificial intelligence-based welding control system according to another embodiment of the present disclosure.

Referring to FIG. 7, an artificial intelligence-based welding control system 700 according to another embodiment of the present disclosure may include a machine vision system 710, a camera 711, a relay system 720 including a relay server 721 and an artificial intelligence (AI) server 722, a welding system 730, and an inspection system 740.

Hereinafter, the machine vision system 710, the relay system 720, and the welding system 730 of the welding control system 700 are similar to the machine vision system 110, the relay system 120, and the welding system 130 of the welding control system 100 of FIG. 1, and therefore will not be described in detail.

The inspection system 740 may inspect whether there is a welding defect after the welding of the welding object is completed through the welding system 730. If a welding defect is detected, the inspection system 740 may transmit welding defect information to the relay system 720. The relay system 720 (e.g., the artificial intelligence server 722) may perform additional training (e.g., updating) of the first artificial intelligence model based on the photography image of the welding object in which the welding defect has occurred. For example, after the photography image of the welding object in which the welding defect has occurred is labeled (e.g., labeled at the correct welding position) by a manager of the artificial intelligence server 722, the artificial intelligence server 722 may perform additional training of the first artificial intelligence model based on the labeled image. In this way, the welding control system 700 of the present disclosure may continuously update the first artificial intelligence model by additionally training the first artificial intelligence model based on the photography images in which the welding position is misrecognized. Through this, the present disclosure may improve (or enhance) the welding position recognition rate of the first artificial intelligence model. Operations for performing additional training of the first artificial intelligence model will be described in detail below with reference to FIG. 8.

FIG. 8 is a flowchart for describing a welding control method of the artificial intelligence-based welding control system according to another embodiment of the present disclosure.

Referring to FIG. 8, steps S801, S803, S805, S807, S809, S811 and S813 of the welding control method of the artificial intelligence-based welding control system according to another embodiment of the present disclosure are the same as the steps S301, S303, S305, S307, S309, S313 and S315 of FIG. 3, and therefore will not be described in detail.

The welding control method may include a step (S815) of requesting a welding inspection. For example, the welding system 730 may request the inspection system 740 to perform a welding inspection of the welding object on which the welding has been completed.

The welding control method may include a step of inspecting whether there is a welding defect (S817) and a step of determining whether a welding defect is present (S819). For example, the inspection system 740 may inspect whether there is a welding defect (e.g., a welding position defect) in the welding object on which the welding has been completed, and determine whether a welding defect is present based on the inspection result. Specifically, the inspection system 740 may photograph the welded secondary battery through a separate camera or the camera 711 of the machine vision system 710, analyze the measured image through an artificial intelligence model (not shown) or a separate machine vision system (not shown) (or the machine vision system 710) to measure the welding position and width, and inspect whether there is a welding defect based on the measurement result. Alternatively, the inspection system 740 may further measure a welding height through a 3D camera, and inspect whether there is a welding defect by reflecting the measured welding height.

As a result of the determination in the step S819, if it is determined that the welding defect is not present, the welding control method may perform a step (S827) of transmitting welding completion information to the relay server 721 of the relay system 720 by the inspection system 740.

On the other hand, as a result of the determination in the step S819, if it is determined that the welding defect is present, the welding control method may perform a step (S821) of transmitting the welding defect information (e.g., the photography image of the welding object in which the welding defect has occurred) to the relay server 721 of the relay system 720 by the inspection system 740, and a step (S823) of transmitting the welding defect information to the artificial intelligence server 722 by the relay server 721.

The welding control method may include a step (S825) of performing additional training (e.g., updating) of the first artificial intelligence model by the artificial intelligence server 722. The artificial intelligence server 722 may perform additional training (e.g., updating) of the first artificial intelligence model based on the photography image of the welding object in which the welding defect has occurred.

Meanwhile, although the welding system 730 and the inspection system 740 are illustrated and described as separate configurations in FIGS. 7 and 8, the welding system 730 and the inspection system 740 may be integrated into a single configuration.

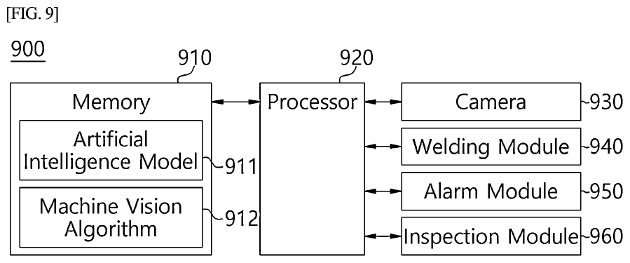

FIG. 9 is a block diagram illustrating a configuration of an artificial intelligence-based welding control apparatus according to an embodiment of the present disclosure.

Referring to FIG. 9, an artificial intelligence-based welding control apparatus 900 according to an embodiment of the present disclosure may include a memory 910, a processor 920, a vision module 930, a welding module 940, an alarm module 950, and an inspection module 960.

The memory 910 may store a program for controlling an operation of the welding control apparatus 900. In addition, the memory 910 may store information necessary to control the operation of the welding control apparatus 900. According to an embodiment, the memory 910 may include an artificial intelligence model 911 and a machine vision algorithm 912. The artificial intelligence model 911 (e.g., the first artificial intelligence model 20) may be pre-trained based on images captured in various environments, and may identify a welding position from the image captured by photographing a welding object using the artificial intelligence technology. The machine vision algorithm 912 may identify a welding position from the image captured using the machine vision technology. Meanwhile, although not shown in the drawings, the memory 910 may further include another artificial intelligence model which extracts a region of interest from the photography image, and is different from the artificial intelligence model 911.

The processor 920 may control an overall operation of the welding control apparatus 900. For example, the processor 920 may control the camera 930 to photograph at least a portion of the welding object, analyze the photography image based on the artificial intelligence model 911 to identify a welding position, determine whether the identified welding position is included in a designated position range, and if the identified welding position is included in the designated position range, control the welding module 940 to perform welding at the identified welding position.

When the welding position is not identified by the artificial intelligence model 911 or the identified welding position is not included in the designated position range, the processor 920 may recognize the welding position using the machine vision algorithm 912. On the other hand, when the welding position is not identified by the machine vision algorithm 912 or the identified welding position is not included in the designated position range, the processor 920 may recognize the welding position using the artificial intelligence model 911. Alternatively, the processor 920 may recognize the welding position by combining the recognition result of the artificial intelligence model 911 and the recognition result of the machine vision algorithm 912 depending on the situation. For example, the processor 920 may recognize the welding position using the machine vision algorithm 912, recognize a size (e.g., a height) of the secondary battery using the artificial intelligence model 911, and apply a designated offset to the welding position depending on the recognized size of the secondary battery. The offset depending on the size of the secondary battery may be set as shown in Table 1 below. Meanwhile, Table 1 is only an example, and does not limit the present disclosure.

TABLE 1

| Size (mm) | Offset (mm) |
|---|---|
| 0 or more but less than 1 | 0.1 |
| 1 or more but less than 1.5 | 0.15 |
| 1.5 or more but less than 2 | 0.2 |
| 2 or more | 0.25 |

The processor 920 may extract a region of interest from the photography image based on the different artificial intelligence model from the artificial intelligence model 911, and identify a welding position within the extracted region of interest using the artificial intelligence model 911 and/or the machine vision algorithm 912.

The processor 920 may control the inspection module 960 to inspect whether there is a welding defect in the welding object that has been welded through the welding module 940. If a welding defect is detected through the inspection module 960, the processor 920 may perform additional training (e.g., updating) of the artificial intelligence model 911 based on the welding defect information (e.g., the photography image of the welding object in which the welding defect has occurred).

If the welding position is not identified or the identified welding position is not included in the designated position range, the processor 920 may control the alarm module 950 to generate an alarm.

The camera 930 may photograph at least a portion of the welding object.

The welding module 940 may perform welding (e.g., laser welding, ultrasonic welding) at the welding position identified through the artificial intelligence model 911 and/or the machine vision algorithm 912.

If the identified welding position is not suitable (e.g., the welding position is not identified, or the identified welding position is not included in the designated position range), the alarm module 950 may generate an alarm. The alarm module 950 may provide at least one of a visual alarm (e.g., emitting a light emitting diode (LED), displaying an icon, displaying a pop-up window, etc.), an audible alarm (e.g., outputting a sound effect), and a tactile alarm (e.g., generating a vibration). The alarm module 950 may include at least one of a light emitting diode, a display, a speaker, and a vibration motor.

The inspection module 960 may inspect whether there is a welding defect after the welding of the welding object is completed through the welding module 940. If a welding defect is detected, the inspection module 960 may transmit welding defect information to the processor 920. The inspection module 960 is similar to the inspection system (940) of FIGS. 7 and 8, and therefore will not be described in detail.

Meanwhile, the welding control apparatus 900 may not include some of the above-described configurations, or may further include other configurations. For example, the welding control apparatus 900 may not include the alarm module 950 and the inspection module 960. As another example, the welding control apparatus 900 may further include a communication module for communicating with an external device. Alternatively, some of the configurations of the welding control apparatus 900 may be formed separately. For example, the welding module 940 and/or the inspection module 960 of the welding control apparatus 900 may be formed as separate external device(s). As another example, although FIG. 9 illustrates and describes that the artificial intelligence model 911 is included in the memory 910 of the welding control apparatus 900, the artificial intelligence model 911 may be included in an external server (e.g., an artificial intelligence server). In this case, the welding control apparatus 900 may further include a communication module (not shown) for performing wired or wireless communication with the external server.

The contents described above are merely an example of applying the principle of the present disclosure, and other configurations may be further included without departing from the scope of the present invention. For example, at least some of the various embodiments of the present disclosure described above may be combined.

What is claimed is:

1. A system for controlling welding based on artificial intelligence, the system comprising:
a machine vision system configured to photograph at least a portion of a welding object through a camera, and transmit the photographed image (hereinafter, “photography image”) to a relay system;
the relay system configured to receive the photography image from the machine vision system, recognize a welding position of the welding object from the received photography image based on a pre-trained first artificial intelligence model, determine whether the recognized welding position is included in a designated position range, and when the recognized welding position is included in the designated position range, transmit the recognized welding position to a welding system; and
the welding system configured to receive the welding position from the relay system, and perform welding at the received welding position.

2. The system according to claim 1, wherein, if the recognized welding position is not included in the designated position range or the welding position is not recognized from the photography image, the relay system generates an alarm.

3. The system according to claim 1, wherein, if the recognized welding position is not included in the designated position range or the welding position is not recognized from the photography image, the relay system requests the machine vision system to identify a welding position, and
if an identification of the welding position is requested, the machine vision system identifies the welding position from the photography image, determines whether the identified welding position is included in the designated position range, and if the identified welding position is included in the designated position range, transmits the identified welding position to the welding system.

4. The system according to claim 3, wherein, if the identified welding position is not included in the designated position range or the welding position is not identified from the photography image, the machine vision system generates an alarm.

5. The system according to claim 1, wherein the machine vision system attempts to identify a welding position from the photography image after photographing at least a portion of the welding object, and if the welding position is not identified from the photography image or the identified welding position is not included in the designated position range, transmits the photography image to the relay system.

6. The system according to claim 5, wherein, if the identified welding position is included in the designated position range, the machine vision system transmits the identified welding position to the welding system.

7. The system according to claim 1, wherein the relay system extracts a region of interest from the photography image based on a pre-trained second artificial intelligence model, and transmits information on the extracted region of interest to the machine vision system, and
the machine vision system identifies a welding position within the region of interest of the photography image, and transmits the identified welding position to the welding system.

8. The system according to claim 1, further comprising an inspection system configured to inspect whether a welding defect is present after performing the welding, and if the welding defect is present, transmit welding defect information to the relay system,
wherein the relay system updates the first artificial intelligence model based on the welding defect information.

9. The system according to claim 1, wherein
the relay system comprises:
an artificial intelligence server which comprises the first artificial intelligence model; and
a relay server configured to relay communication between the machine vision system, the welding system, and the artificial intelligence server.

10. The system according to claim 1, wherein the welding object comprises a secondary battery, and
the welding position comprises an edge of an electrode of the secondary battery.

11. A method for controlling welding based on artificial intelligence, the method comprising:
photographing at least a part of the welding object through a camera, and transmitting the photographed image (hereinafter, “photography image”) to a relay system by a machine vision system;
receiving the photography image from the machine vision system, recognizing a welding position of the welding object from the received photography image based on a pre-trained first artificial intelligence model, determining whether the recognized welding position is included in a designated position range, and when the recognized welding position is included in the designated position range, transmitting the recognized welding position to a welding system by the relay system;
receiving the welding position from the relay system, and performing welding at the received welding position by the welding system.

12. The method according to claim 11, further comprising, if the recognized welding position is not included in the designated position range or the welding position is not recognized from the photography image, generating an alarm by the relay system.

13. The method according to claim 11, further comprising:
if the recognized welding position is not included in the designated position range or the welding position is not recognized from the photography image, requesting the machine vision system to identify a welding position by the relay system; and
if an identification of the welding position is requested, identifying the welding position from the photography image, determining whether the identified welding position is included in the designated position range, and if the identified welding position is included in the designated position range, transmitting the identified welding position to the welding system by the machine vision system.

14. The method according to claim 13, further comprising, if the identified welding position is not included in the designated position range or the welding position is not identified from the photography image, generating an alarm by the machine vision system.

15. The method according to claim 11, further comprising
attempting to identify a welding position from the photography image after photographing at least a portion of the welding object by the machine vision system,
wherein, if the welding position is not identified from the photography image or the identified welding position is not included in the designated position range, the step of transmitting the photography image to the relay system is performed.

16. The method according to claim 15, further comprising, if the identified welding position is included in the designated position range, transmitting the identified welding position to the welding system by the machine vision system.

17. The method according to claim 11, further comprising:
extracting a region of interest from the photography image based on a pre-trained second artificial intelligence model, and transmitting information on the extracted region of interest to the machine vision system by the relay system; and
identifying a welding position within the region of interest of the photography image, and transmitting the identified welding position to the welding system by the machine vision system.

18. The method according to claim 11, further comprising:
inspecting whether a welding defect is present through an inspection system after performing the welding;
if the welding defect is present, transmitting welding defect information to the relay system; and
updating the first artificial intelligence model based on the welding defect information by the relay system.

19. An apparatus for controlling welding based on artificial intelligence, the apparatus comprising:
a camera;
a memory which comprises a pre-trained artificial intelligence model;
a welding module; and
a processor configured to control the camera to photograph at least a portion of a welding object, recognize a welding position from the image photographed through the camera (hereinafter, “photography image”) based on the artificial intelligence model, determine whether the recognized welding position is included in a designated position range, and when the recognized welding position is included in the designated position range, control the welding module to weld the recognized welding position.

20. The apparatus according to claim 19, further comprising an inspection module,
wherein the processor determines whether a welding defect is present through the inspection module after performing the welding, and if the welding defect is present, updates the artificial intelligence model based on welding defect information.
